(19) United States
(12) Patent Application Publication
(10) Pub. No.: US 2025/0150821 A1
(43) Pub. Date: May 8, 2025

(54) Negotiation Mechanism for Authentication Procedures in Edge Computing

(71) Applicant: Apple Inc., CUPERTINO, CA (US)

(72) Inventors: Shu GUO, Beijing (CN); Chunxuan YE, San Diego, CA (US); Dawei ZHANG, Saratoga, CA (US); Haijing HU, Los Gatos, CA (US); Huaning NIU, San Jose, CA (US); Huarui LIANG, Beijing (CN); Lanpeng CHEN, Beijing (CN); Xiaoyu QIAO, Beijing (CN); Weidong YANG, San Diego, CA (US)

(21) Appl. No.: 18/833,654

(22) PCT Filed: Jan. 28, 2022
(86) PCT No.: PCT/CN2022/074724

§ 371 Date: Jul. 26, 2024

(51) Int. Cl. H04W 12/069

(52) U.S. Cl. CPC H04W 12/069

(57) ABSTRACT

A user equipment (UE) is configured to transmit a request to an edge configuration server (ECS) comprising a list of authentication mechanisms supported by the UE, wherein the ECS is configured to select one authentication mechanism from the list of authentication mechanisms and receive a response to the request from the ECS, wherein response comprises an indication of the selected authentication mechanism.

### TECHNICAL FIELD

The present disclosure generally relates to communication, and in particular, to a negotiation mechanism for authentication procedures in edge computing.

### BACKGROUND

A user equipment (UE) may connect to an edge data network to access edge computing services. Edge computing refers to performing computing and data processing at the network where the data is generated. To establish a connection with the edge data network, the UE may have to perform an authentication procedure with an edge data network. It has been identified that there is a need for a negotiation procedure to allow the UE and the network to decide which authentication mechanism is to be utilized.

### SUMMARY

Some exemplary embodiments are related to a processor of a user equipment (UE) configured to perform operations. The operations include transmitting a request to an edge configuration server (ECS) comprising a list of authentication mechanisms supported by the UE, wherein the ECS is configured to select one authentication mechanism from the list of authentication mechanisms and receiving a response to the request from the ECS, wherein response comprises an indication of the selected authentication mechanism.

Other exemplary embodiments are related to an edge configuration server (ECS) configured to perform operations. The operations include receiving a request from a user equipment (UE) comprising a list of authentication mechanisms supported by the UE, selecting one authentication mechanism from the list of authentication mechanisms and transmitting a response to the request to the UE, wherein response comprises an indication of the selected authentication mechanism.

Still further exemplary embodiments are related to a user equipment (UE) having a transceiver configured to communicate with a network and a processor communicatively coupled to the transceiver and configured to perform operations. The operations include transmitting a request to an edge configuration server (ECS) comprising a list of authentication mechanisms supported by the UE, wherein the ECS is configured to select one authentication mechanism from the list of authentication mechanisms and receiving a response to the request from the ECS, wherein response comprises an indication of the selected authentication mechanism.

Additional exemplary embodiments are related to a method that includes receiving a request from a user equipment (UE) comprising a list of authentication mechanisms supported by the UE, selecting one authentication mechanism from the list of authentication mechanisms and transmitting a response to the request to the UE, wherein response comprises an indication of the selected authentication mechanism.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an architecture for enabling edge applications according to various exemplary embodiments.

FIG. 4 shows a signaling diagram for an independent negotiation procedure according to various exemplary embodiments.

FIG. 5 shows a signaling diagram for an integrated negotiation procedure according to various exemplary embodiments.

### DETAILED DESCRIPTION

The exemplary embodiments may be further understood with reference to the following description and the related appended drawings, wherein like elements are provided with the same reference numerals. The exemplary embodiments relate to implementing a negotiation procedure to decide which authentication procedure is to be utilized for access to an edge data network.

The exemplary embodiments are described with regard to a user equipment (UE). However, reference to a UE is merely provided for illustrative purposes. The exemplary embodiments may be utilized with any electronic component that is configured with the hardware, software, and/or firmware to exchange information and data with the network. Therefore, the UE as described herein is used to represent any appropriate electronic component.

The exemplary embodiments are also described with regard to a fifth generation (5G) New Radio (NR) network. However, reference to a 5G NR network is merely provided for illustrative purposes. The exemplary embodiments may be utilized with any network that allows the UE to access an edge data network.

The UE may access the edge data network via the 5G NR network. The edge data network may provide the UE with access to edge computing services. Those skilled in the art will understand that edge computing refers to performing computing and data processing at the network where the data is generated. In contrast to legacy approaches that utilize a centralized architecture, edge computing is a distributed approach where data processing is localized towards the network edge, closer to the end user. This allows performance to be optimized and latency to be minimized.

In addition, the exemplary embodiments are described with regard to different types of authentication procedures that may be utilized between the UE and an edge data network. Generally, an authentication procedure may be performed prior to the flow of application data traffic between the UE and an edge application server (EAS) of the edge data network. For instance, both transport layer security (TLS) with authentication and key management for application (AKMA) and TLS with generic bootstrapping architecture (GBA) may be supported. However, any reference to a particular type of authentication procedure is provided for illustrative purposes. The exemplary negotiating mechanisms described herein may be applied to any appropriate set of authentication procedures.

Under conventional circumstances, there is no negotiation procedure to determine which authentication is to be utilized by the UE and the edge data network. As a result, scenarios may occur in which the UE and the edge data network select different authentication procedures that are not compatible with one another. This may cause connectivity issues and delay access to edge computing services. In addition, UE, cellular network and/or edge data network resources are unnecessarily wasted when incompatible authentication procedures are implemented. The exemplary embodiments introduce a negotiation mechanism that allows the UE and the edge data network to determine which authentication procedure is to be utilized to avoid the above-referenced issues.

In one aspect, the exemplary embodiments introduce a negotiation procedure that is independent from the authentication procedure. Throughout this description, the exemplary embodiments may refer to this type of negotiation procedures as an “independent negotiation procedure.” In another aspect, the exemplary embodiments introduce a negotiation procedure that is integrated with an authentication procedure. Throughout this description, the exemplary embodiments may refer to this type of negotiation procedure as an “integrated authentication procedure.” However, reference to the terms “independent negotiation procedures” and “integrated authentication procedure is provided for illustrative purposes. Different entities may refer to similar concepts by different names.

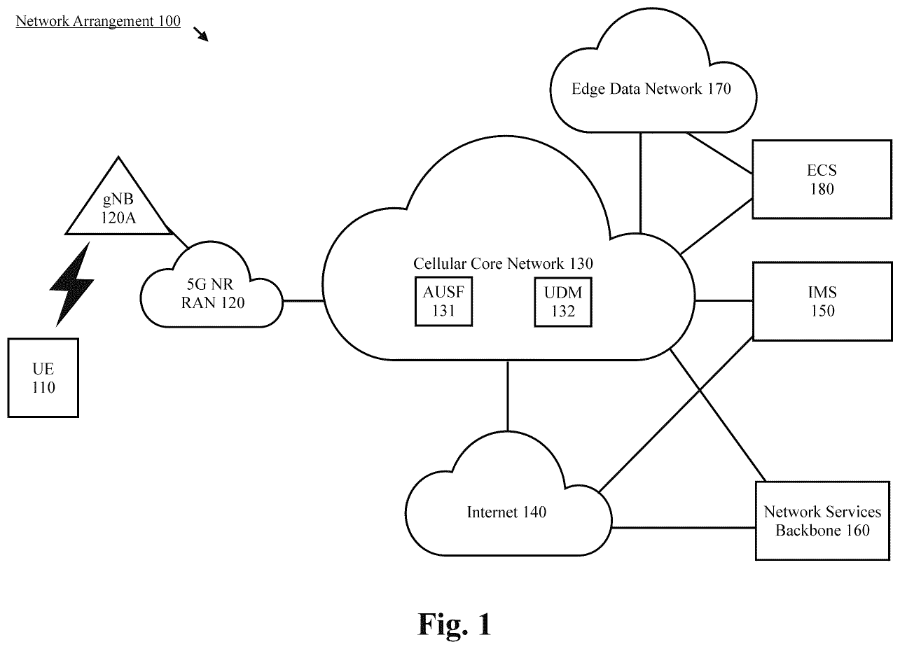

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as indicated above, the 5G NR RAN 120 may be associated with a particular cellular provider where the UE 110 and/or the user thereof has a contract and credential information (e.g., stored on a SIM). Upon detecting the presence of the 5G NR RAN 120, the UE 110 may transmit the corresponding credential information to associate with the 5G NR RAN 120. More specifically, the UE 110 may associate with a specific base station (e.g., gNB 120A).

The network arrangement 100 also includes a cellular core network 130. The cellular core network 130 may be considered as an interconnected set of components or functions that manage the operation and traffic of the cellular network. In this example, the components include an authentication server function (AUSF) 131 and a unified data management (UDM) 132. However, an actual network arrangement may include various other components performing any of a variety of different functions.

The AUSF 131 may store data for authentication of UEs and handle authentication-related functionality. The AUSF 131 may be equipped with one or more communication interfaces to communicate with other network components (e.g., network functions, RANs, UEs, etc.). The exemplary embodiments are not limited to a AUSF that performs the above reference operations. Those skilled in the art will understand the variety of different types of operations a AUSF may perform. Further, reference to a single AUSF 131 is merely for illustrative purposes, an actual network arrangement may include any appropriate number of AUSFs.

The UDM 132 may perform operations related to handling subscription-related information to support the network's handling of communication sessions. The UDM 132 may be equipped with one or more communication interfaces to communicate with other network components (e.g., network functions, RANs, UEs, etc.). The exemplary embodiments are not limited to an UDM that performs the above reference operations. Those skilled in the art will understand the variety of different types of operations a UDM may perform. Further, reference to a single UDM 132 is merely for illustrative purposes, an actual network arrangement may include any appropriate number of UDMs.

The network arrangement 100 also includes the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

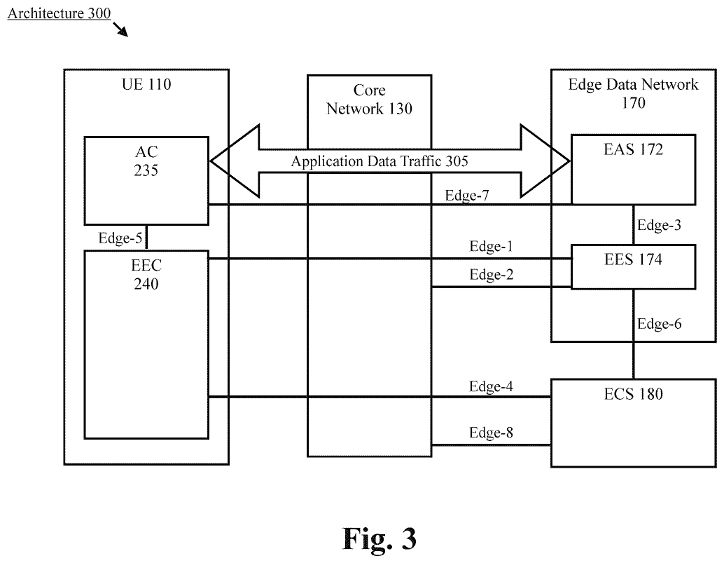

In addition, the network arrangement 100 includes an edge data network 170 and an edge configuration server (ECS) 180. The exemplary embodiments are described with regard to authentication procedures. These authentication procedures may include interactions between the UE 110, the edge data network 170 and the ECS 180. The edge data network 170 and the ECS 180 will be described in more detail below with regard to FIG. 3. Those skilled in the art will understand that an actual network arrangement may include any appropriate number of edge data networks and ECSs. Thus, the example of a single edge data network 170 and single ECS 180 is merely provided for illustrative purposes.

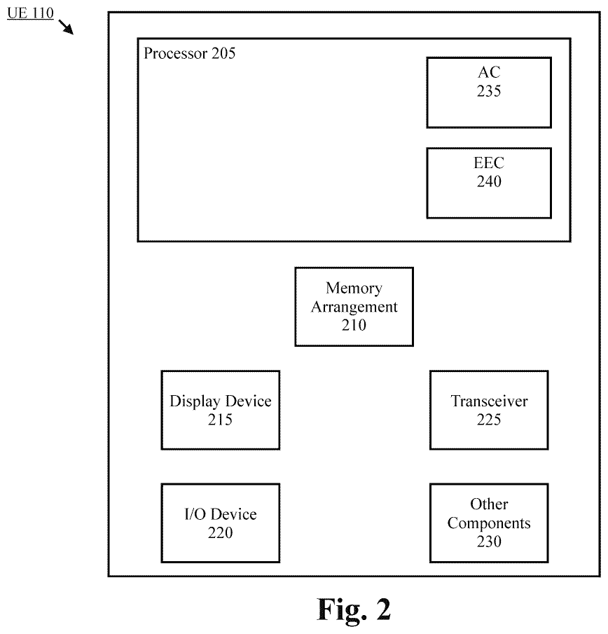

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute various types of software. For example, the processor may execute an application client (AC) 235 and an edge enabler client (EEC) 240. The AC 235 may perform operations related to exchanging application data with a server via a network. The EEC 240 may perform operations in support of the AC 235. For example, the EEC 240 may perform a negotiation procedure with an edge data network to determine which authentication procedure is to be utilized. Reference to a single AC 235 and EEC 240 is merely provided for illustrative purposes. The UE 110 may be equipped with any appropriate number of application clients supported by an appropriate number of EECs. The AC 235 and the EEC 240 are discussed in more detail below with regard to FIG. 3.

The above referenced software being executed by the processor 205 is only exemplary. The functionality associated with the software may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

FIG. 3 shows an architecture 300 for enabling edge applications according to various exemplary embodiments. The architecture 200 will be described with regard to the network arrangement 100 of FIG. 1.

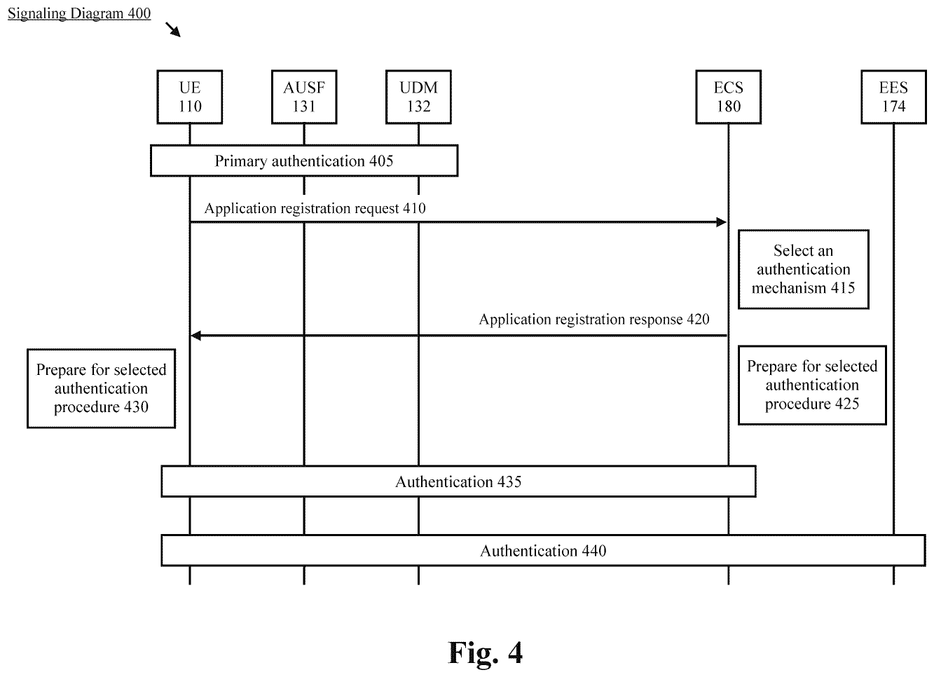

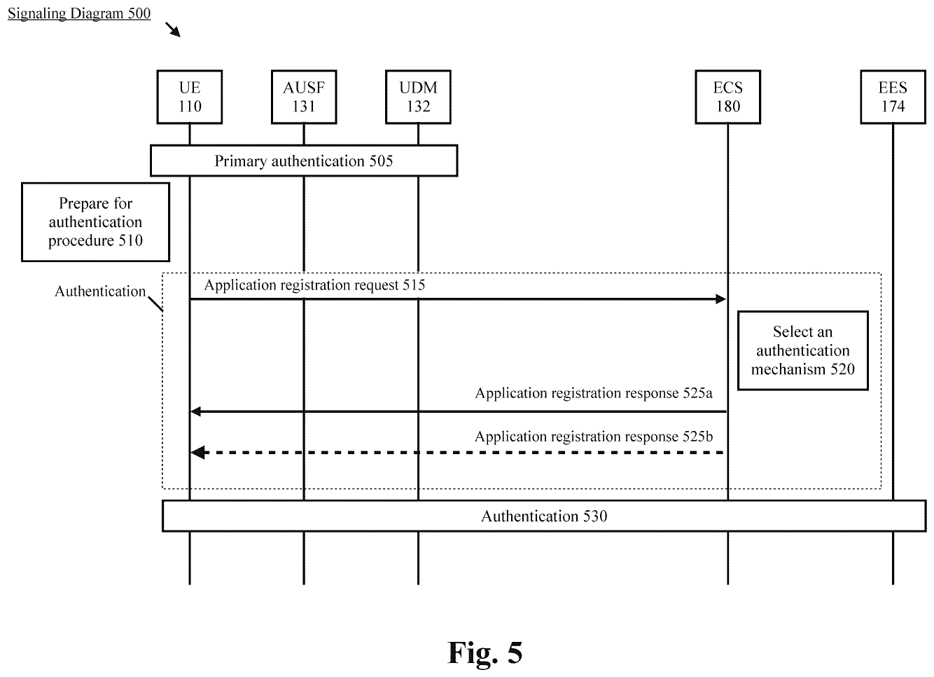

The exemplary embodiments will be described with regard to a negotiation procedure for determining which authentication procedure is to be utilized to enable the UE 110 to access to the edge data network 170. Successful completion of the exemplary negotiation procedure may precede the flow of application data traffic 305 between the edge data network 170 and the UE 110. The architecture 300 provides a general example of the type of components that may interact with one another for enabling edge applications. Specific examples of the exemplary negotiation procedures will be provided below with regard to the signaling diagram 400 of FIG. 4 and the signaling diagram 500 of FIG. 5.

The architecture 300 includes the UE 110, the core network 130 and the edge data network 170. The UE 110 may establish a connection to the edge data network 170 via the core network 130 and various other components (e.g., cell 120A, the 5G NR RAN 120, network functions, etc.).

In the architecture 300, the various components are shown as being connected via reference points labeled edge-x (e.g., edge-1, edge-2, edge-3, edge-4, edge-5, edge-6, edge-7, edge-8, etc.). Those skilled in the art will understand that each of these reference points (e.g., connections, interfaces, etc.) are defined in the 3GPP Specifications. In this description, these reference points may be used in the manner in which they are defined in the 3GPP Specifications and may be modified in accordance with the exemplary embodiments described here. Furthermore, while these interfaces are termed reference points throughout this description, those skilled in the art will understood that these interfaces are not required to be direct wired or wireless connections, e.g., the interfaces may communicate via intervening hardware and/or software components. To provide an example, the UE 110 may exchange signals over the air with the gNB 120A. However, in the architecture 300 the UE 110 is shown as having a direct connection to the edge configuration server (ECS) 180. Those skilled in the art will understand that this connection is not a direct communication link between the UE 110 and the ECS 180. Instead, this is a connection that is facilitated by intervening hardware and software components. Thus, throughout this description the terms “connection,” “reference point” and “interface” may be used interchangeably to describe the interfaces between the various components in the architecture 300 and the network arrangement 100.

During operation, application data traffic 305 may flow between the AC 235 running on the UE 110 and the edge application server (EAS) 172 of the edge data network 170. The EAS 172 may be accessed through the core network 130 via uplink classifiers (CL) and branching points (NP) or in any other appropriate manner. Those skilled in the art will understand the variety of different types of operations and configurations relevant to an application client and an EAS. The operations performed by these components are beyond the scope of the exemplary embodiments. Instead, these components are included in the description of the architecture 300 to demonstrate that the exemplary negotiation procedure may precede the flow of application data traffic 305 between the UE 110 and the edge data network 170.

The EEC 240 may be configured to provide supporting functions for the AC 235. For example, the EEC 240 may perform operations related to concepts such as, but not limited to, the discovery of EASs that are available in an edge data network (e.g., EAS 172) and the retrieval and provisioning of configuration information that may enable the exchange of the application data traffic 305 between the AC 235 and the EAS 172. To differentiate the EEC 240 from other EECs, the EEC 240 may be associated with a globally unique value (e.g., EEC ID) that identifies the EEC 240. Further, reference to a single AC 235 and EEC 240 is merely provided for illustrative purposes, the UE 110 may be equipped with any appropriate number of application clients and EECs.

The edge data network 170 may also include an edge enabler server (EES) 174. The EES 174 may be configured to provide supporting functions to the EAS 172 and the EEC 240 running on the UE 110. For example, the EES 174 may perform operations related to concepts such as, but not limited to, provisioning configuration to enable the exchange of the application data traffic 305 between the UE 110 and the EAS 172 and providing information related to the EAS 172 to the EEC 240 running on the UE 110. Those skilled in the art will understand the variety of different types of operations and configurations relevant to an EES. Further, reference to the edge data network 170 including a single EAS 172 and a single EES 174 is merely provided for illustrative purposes. In an actual deployment scenario, an edge data network may include any appropriate EASs and EESs interacting with any number of UEs.

The ECS 180 may be configured to provide supporting functions for the EEC 240 to connect the EES 174. For example, the ECS 180 may perform operations related to concepts such as, but not limited to, provisioning of edge configuration information to the EEC 240. The edge configuration information may include the information for the EEC 240 to connect to the EES 174 (e.g., service area information, etc.) and the information for establishing a connection with the EES 174 (e.g., uniform resource identifier (URI). Those skilled in the art will understand the variety of different types of operations and configurations relevant to an ECS.

In the network architecture 100 and the enabling architecture 300, the ECS 180 is shown as being outside of the edge data network 170 and the core network 130. In addition, the EAS 172 and the EES 174 are shown as being inside of the edge data network 170. However, these examples are merely provided for illustrative purposes. The EAS 172, the EES 172 and the ECS 180 may be deployed in any appropriate virtual and/or physical location (e.g., within the mobile network operator's domain or within a third party domain) and implemented via any appropriate combination of hardware, software and/or firmware.

As mentioned above, in one aspect, the exemplary embodiments introduce a negotiation procedure that is independent from the authentication procedure, e.g., an independent negotiation procedure. In this approach, messages are introduced that enable the UE 110 and the edge data network 170 to negotiate which authentication procedure is to be utilized. An example of these messages is described below with regard to the signaling diagram 400 of FIG. 4.

FIG. 4 shows a signaling diagram 400 for an independent negotiation procedure according to various exemplary embodiments. The signaling diagram 400 includes the UE 110, the AUSF 131, the UDM 132, the ECS 180 and the EES 174.

In 405, primary authentication is performed. Those skilled in the art will understand that primary authentication may be performed between the UE 110 and network functions such as, but not limited to, the AUSF 131 and the UDM 132. Subsequently, the UE 110 is successfully registered into the network. After primary authentication is performed, the UE 110 may initiate the negotiation procedure with the ECS 180.

In 410, the UE 110 sends an application registration request message to the ECS 180. This exemplary message may include a list of authentication mechanisms supported at the UE 110 and any other appropriate parameters. In this example, the list may include one or more of TLS with AKMA, TLS GBA and TLS with certificate. However, these example authentication mechanisms are merely provided for illustrative purposes, the exemplary embodiments may apply to any appropriate number or type of authentication mechanisms. In addition, the request may include parameters such as, but not limited to, a UE ID, a generic public subscription identifier (GPSI), an EEC ID, etc.

In some embodiments, the UE 110 may implicitly or explicitly indicate a preference for the supported authentication mechanisms. For example, the UE 110 may format the message to indicate that a first type of authentication procedure is associated with a highest priority, a second type of supported authentication procedure is associated with a second highest priority and a third type of authentication procedure associated with a lowest priority. The ECS 180 may consider the priority indication or preference when selecting an authentication procedure for the UE 110.

In 415, the ECS 180 selects an authentication mechanism. The ECS 180 may select one of the authentication mechanisms from the list of authentication mechanisms provided in 410. In 420, the ECS 180 sends an application registration response to the UE 110. The application registration response may include the authentication mechanisms selected by the ECS 180 and any other appropriate mechanism. However, reference to the terms “application registration request” and “application registration response” are provided for illustrative purposes. Different entities may refer to similar messages by a different name.

In 425, the ECS 180 prepares for the selected authentication procedure. For example, after sending the application registration response, the ECS 180 or any other appropriate component may generate AKMA keys, GBA keys, certificates or any other appropriate type of information that is to be used in the selected authentication procedure.

In 430, in response to the application registration response, the UE 110 prepares for the selected authentication procedure. For example, the UE 110 may generate AKMA keys, GBA keys, certificates or any other appropriate type of information that are to be used in the selected authentication procedure. In other embodiments, the UE 110 may prepare for supported authentication procedures prior to the reception of the of the application registration request or at any other appropriate time.

In 435, the UE 110 performs the selected authentication procedure with the ECS 180. In 440, the UE 110 performs an authentication procedure with the EES 174. In some embodiments, the authentication procedure performed between the UE 110 and the EES 174 may be the selected authentication procedure, e.g., the same authentication procedure performed between the UE 110 and the ECS 180. Thus, the exemplary negotiation procedure described herein may be applicable to multiple different authentication procedures. However, the exemplary embodiments are not required to be used for multiple different authentication procedures. The exemplary negotiation procedure described herein may be used to select an authentication mechanism for any appropriate number of one or more different authentication procedures.

In another aspect, the exemplary embodiments introduce a negotiation procedure that is integrated with an authentication procedure, e.g., integrated authentication procedure. In this approach, the UE 110 provides a list of supported authentication mechanisms within a message of the authentication procedure. An example of this approach is described below with regard to the signaling diagram 500 of FIG. 5.

FIG. 5 shows a signaling diagram 500 for an independent negotiation procedure according to various exemplary embodiments. The signaling diagram 500 includes the UE 110, the AUSF 131, the UDM 132, the ECS 180 and the EES 174.

In 505, primary authentication is performed. Those skilled in the art will understand that primary authentication may be performed between the UE 110 and network functions such as, but not limited to, the AUSF 131 and the UDM 132. Subsequently, the UE 110 is successfully registered into the network.

In 510, the UE 110 may prepare for authentication. For example, the UE 110 may generate AKMA keys, GBA keys, certificates or any other appropriate type of information. Thus, in some embodiments, the UE 110 may generate this information prior to negotiating the authentication procedure. However, the exemplary embodiments are not limited to this example, the UE 110 may prepare for the authentication procedure at any appropriate time.

In 515, the UE 110 sends an application registration request to the ECS 180. The application registration request may include a list of authentication procedures supported by the UE 110. In some embodiments, the UE 110 may implicitly or explicitly indicate a preference for the supported authentication mechanisms. For example, the UE 110 may format the message to indicate that a first type of authentication procedure is associated with a highest priority, a second type of supported authentication procedure is associated with a second highest priority and a third type of authentication procedure associated with a lowest priority. The ECS 180 may consider the priority indication or preference when selecting an authentication procedure for the UE 110.

In some embodiments, the application registration request may also include credentials for one or more authentication mechanisms. For example, the keys or certificates generated in 510 may be included in the application registration request. In addition, the UE 110 may provide other information such as, but not limited to, a UE ID, an EEC ID, a GPSI. Further, since the negotiation procedure has been integrated into the authentication procedure, this message may be considered the first message of an authentication procedure between the UE 110 and the ECS 180. Thus, the request may include any appropriate type of information relevant to the performance of an authentication procedure. Further, although a single message is shown in the signaling diagram 500, in an actual deployment scenario, this type of information may be provided in any appropriate type or number of different messages.

In 520, the ECS 180 selects an authentication mechanism. In some examples, depending on the contents of the application registration request, the ECS 180 may have a choice between an authentication procedure with corresponding credentials already provided by the UE 110 or an authentication procedure where the credentials have not yet been provided by the UE 110.

In 525a, it is assumed that the ECS 180 selected an authentication procedure with corresponding credentials already provided by the UE 110. Thus, the EEC 180 may complete the authentication procedure which may include generating keys or certificates and communicating network functions to verify the UE 110. Accordingly, in 525a, the ECS 180 may transmit an application registration response to the UE 110. The application registration response may include an indicate that the negotiation procedure was successful (e.g., a token, etc.).

In 525b, it is assumed that the ECS 180 selected an authentication procedure where the credentials were not yet provided by the UE 110. Thus, in 525b, the ECS 180 may transmit an application registration response to the UE 110. The application registration response may include a reject message, a cause code, an error code and/or indicate the selected authentication mechanism to be utilized. Subsequently, the UE 110 and the ECS 180 may perform the selected authentication procedure (not shown in the signaling diagram 500). In the signaling diagram 500, reference to the terms “application registration request” and “application registration response” are provided for illustrative purposes. Different entities may refer to similar messages by a different name.

In 530, the UE 110 performs an authentication procedure with the EES 174. In some embodiments, the authentication procedure performed between the UE 110 and the EES 174 may be the selected authentication procedure, e.g., the same authentication procedure performed between the UE 110 and the ECS 180. Thus, the exemplary negotiation procedure described herein may be applicable to multiple different authentication procedures. However, the exemplary embodiments are not required to be used for multiple different authentication procedures. The exemplary negotiation procedure described herein may be used to select an authentication mechanism for any appropriate number of one or more different authentication procedures.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described methods may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
generate, for transmission to an edge configuration server (ECS), a request comprising a list of authentication mechanisms supported by the UE, wherein the ECS is configured to select one authentication mechanism from the list of authentication mechanisms; and
process, based on signaling from the ECS, a response to the request ECS, wherein response comprises an indication of the selected authentication mechanism.

2. The apparatus of claim 1, wherein the processing circuitry is further configured to:
generate, after the reception of the response, a key or a certificate for the selected authentication mechanism.

3. The apparatus of claim 1, wherein the processing circuitry is further configured to:
generate, prior to the reception of the response, a key or a certificate for one or more authentication mechanisms included in the list of authentication mechanisms.

4. The apparatus of claim 1, wherein the processing circuitry is further configured to:
initiate an authentication procedure with the ECS using the selected authentication mechanism.

5. The apparatus of claim 1, wherein the processing circuitry is further configured to:
generate, prior to transmitting the request, credentials corresponding to an authentication mechanism included in the list of authentication mechanism supported by the UE, wherein the credentials are included in the request.

6. The apparatus of claim 5, wherein the request is a first message of an authentication procedure between the UE and the ECS.

7. The apparatus of claim 5, wherein the request includes two or more authentication mechanisms comprising at least a first authentication mechanism with corresponding credentials and a second authentication mechanisms without corresponding credentials.

8. The apparatus of claim 7, wherein the selected authentication mechanism is the first authentication mechanism and the response further indicates that a negotiation between the UE and the ECS is successful.

9. The apparatus of claim 7, wherein the selected authentication mechanism is the second authentication mechanism, wherein the processing circuitry is further configured to:
generate credentials for the selected authentication mechanisms based on the response.

10. The apparatus of claim 7, wherein the request is configured to indicate that the first authentication procedure is prioritized over the second authentication procedure by the UE.

11. An edge configuration server (ECS) configured to:
process a request from a user equipment (UE) comprising a list of authentication mechanisms supported by the UE;
select one authentication mechanism from the list of authentication mechanisms; and
send a response to the request to the UE, wherein response comprises an indication of the selected authentication mechanism.

12. The ECS of claim 11, further configured to:
generate, after selecting the authentication mechanism and prior to transmitting the response, a key or a certificate for the selected authentication mechanism.

13. The ECS of claim 11, further configured to:
perform an authentication procedure with the UE using the selected authentication mechanism.

14. The ECS of claim 11, wherein the request further comprises credentials generated by the UE corresponding to an authentication mechanism included in the list of authentication mechanism supported by the UE.

15. The ECS of claim 11, wherein the request is a first message of an authentication procedure between the UE and the ECS.

16. The ECS of claim 11, wherein the request includes a first authentication mechanism with corresponding credentials generated by the UE and a second authentication mechanisms without corresponding credentials generated by the UE.

17. The ECS of claim 16, wherein the selected authentication mechanism is the first authentication mechanism and the response further indicates that authentication between the UE and the ECS is successful.

18. The ECS of claim 16, wherein the selected authentication mechanism is the second authentication mechanism, wherein the ECS is further configured to:
perform an authentication procedure with the UE using the selected authentication mechanisms.

19. A user equipment (UE), comprising:
a transceiver configured to communicate with a network; and
a processor communicatively coupled to the transceiver and configured to perform operations comprising:
transmitting a request to an edge configuration server (ECS) comprising a list of authentication mechanisms supported by the UE, wherein the ECS is configured to select one authentication mechanism from the list of authentication mechanisms; and
receiving a response to the request from the ECS, wherein response comprises an indication of the selected authentication mechanism.

20. The UE of claim 19, the operations further comprising:
generating, after the reception of the response, a key or a certificate for the selected authentication mechanism.

21-36. (canceled)
